(19) United States
(12) Patent Application Publication
(10) Pub. No.: US 2026/0045175 A1
(43) Pub. Date: Feb. 12, 2026

(54) COORDINATION IMPROVEMENT DEVICE

(71) Applicant: Juan Gonzalez, Moreno Valley, CA (US)

(72) Inventor: Juan Gonzalez, Moreno Valley, CA (US)

(21) Appl. No.: 19/298,044

(22) Filed: Aug. 12, 2025

Related U.S. Application Data
(60) Provisional application No. 63/682,238, filed on Aug. 12, 2024.

(51) Int. Cl. G09B 15/00; G10D 13/03; G10H 3/14

(52) U.S. Cl. CPC G09B 15/00; G10D 13/03; G10H 3/146; G10H 2220/461

(57) ABSTRACT

A coordination improvement device is disclosed. The device includes a platform and a plurality of pads disposed on, and arranged around, the platform. The device may take various configurations and sizes to be utilized by the user to increase ambidexterity. For example, the device can be configured as a drum coordination kit with the pads configured to be stuck by drum sticks.

### CROSS-REFERENCE TO RELATED APPLICATIONS

This application claims the benefit of U.S. Provisional Application No. 63/682,238, filed on Aug. 12, 2024, the teachings of which are expressly incorporated by reference.

### STATEMENT RE: FEDERALLY SPONSORED RESEARCH/DEVELOPMENT

Not Applicable

### BACKGROUND

The present disclosure relates generally to devices for improving a user's coordination, specifically hand and/or feet coordination, and more particularly to a drum coordination device for improving both hands of a user for drumming purposes.

In general, people generally have a more dominant hand and/or foot. Certain activities, for example, playing the drums, would be improved if a user had equal strength and coordination between their hands and feet.

In order to overcome these problems, various solutions have been introduced. For example, people have drawn targets on drum heads. Additionally, there are prior art drum practice devices that are intended to improve a person's drumming skills. For example, the Drumeo P4 practice pad has four different materials to simulate different drums within a drum kit to allow a user to practice their drumming skills. However, there has not been a practice device that serves to equalize and develop a user's weaker hand.

As such, there is a need for a coordination improvement device capable of improving both hands and/or feet of a user to equalize the user's capabilities between the two sides, and in particular there is a need for a drum coordination device that will improve a drummer's skills and ability in both of their hands when drumming.

### BRIEF SUMMARY

In accordance with one embodiment of the present disclosure, there is contemplated a coordination improvement device. The coordination improvement device includes a platform and a plurality of pads disposed on, and arranged around, the platform. The platform may be generally circular in shape.

Furthermore, the platform may have a plurality of extensions extending outward from the platform. In one embodiment, there are eight extensions. In that embodiment, two of the eight extensions may be wider than the remaining six extensions. The device may be configured such that the two wider extensions extend outward diametrically opposite of each other from the platform.

The device may be configured such that two pads are disposed on each of the two wider extensions and one pad is disposed on each of the six remaining extensions. In certain embodiments, the coordination improvement device may further include two pads disposed in the center of the platform.

In some embodiments the pads may be circular. Additionally, the pads may be visually distinguishable in pairs. In some embodiments the visually distinguishable pairs may be matching colors. In other embodiments the visually distinguishable pairs may be matching patterns. In one embodiment there may be twelve pads disposed on the platform.

In one embodiment, the device may be configured as a drum coordination device, with the plurality of pads being strikable by a drum stick.

In another embodiment, the device may be configured as a foot coordination device, with the platform capable of being placed on a floor and sized such that the plurality of pads are strikable by a user's feet.

In yet another embodiment, the device may be configured as a toss coordination device, with the plurality of pads being hollow cylinders capable of receiving a ball and the device capable of being mounted in a predominantly vertical position.

In yet another embodiment, the device may be configured as a dart coordination device, with the plurality of pads being configured to detachably receive a dart and the device capable of being mounted in a predominantly vertical position.

In some embodiments, the device may further include electronic components, including a speaker, such that the speaker is capable of playing an output when a pad is struck. In these electronic embodiments, the plurality of pads may be programmable to make a certain sound when struck and/or each pad may be programmable to make a different sound from other pads.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a drum coordination device embodiment of the present invention.

FIG. 2 is a broken apart view of FIG. 1, showing the various components of the drum coordination device.

FIG. 3 is a top view of the drum coordination device.

FIG. 4 is a bottom view of the drum coordination device.

FIG. 5A is a perspective view of a pad used in the drum coordination device.

FIG. 5B is a see-through version of the pad shown in FIG. 5A.

FIG. 5C is a top view of the pad shown in FIG. 5A.

FIG. 5D is a bottom view of the pad shown in FIG. 5A.

FIG. 6 is a side view of a connecting device used in the drum coordination device.

FIG. 7 is a perspective view of a toss coordination device embodiment of the present invention.

FIG. 8 is a top view of the toss coordination device.

FIG. 9 is a bottom view of the toss coordination device.

FIG. 10A is a perspective view of a cylinder pad used in the toss coordination device.

FIG. 10B is a see-through version of the cylinder pad shown in FIG. 10A.

FIG. 11 is a side view of the toss coordination device.

FIG. 12 is a perspective view of a dart coordination device embodiment of the present invention.

FIG. 13 is a top view of the dart coordination device.

FIG. 14 is a bottom view of the dart coordination device.

FIG. 15A is a perspective view of a pad used in the dart coordination device.

FIG. 15B is a see-through version of the pad shown in FIG. 15A.

FIG. 15C is a top view of the pad shown in FIG. 15A.

FIG. 15D is a bottom view of the pad shown in FIG. 15A.

FIG. 16 is a side view of a connecting device used in the dart coordination device.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

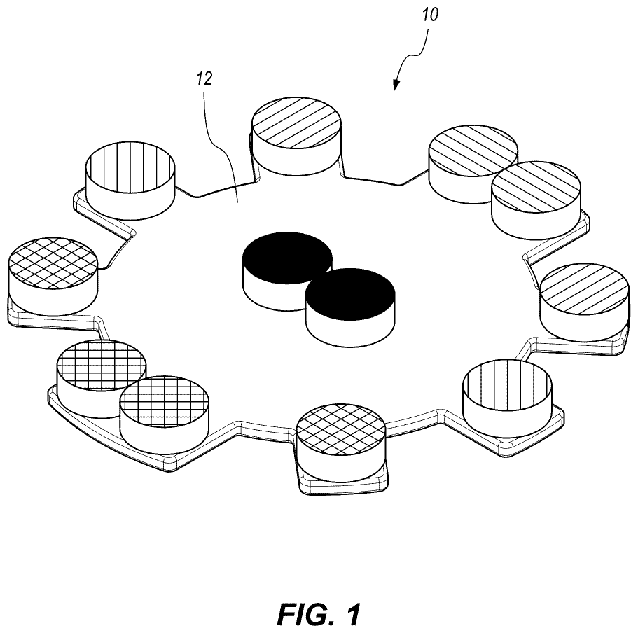

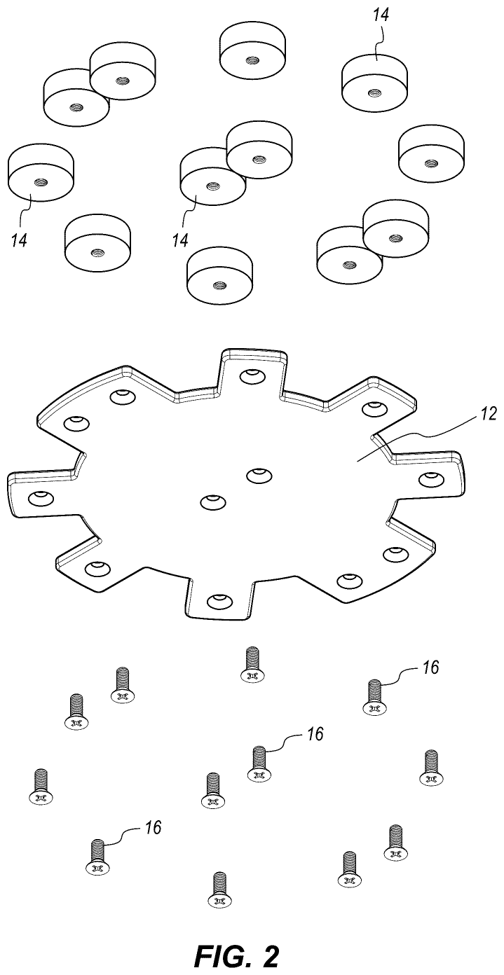

Described herein are various coordination improvement devices. One embodiment encompasses a drum coordination device 10 as shown in FIG. 1. The drum coordination device 10 is divided into two sections, a left side 10a intended to be played by a user's left hand, and a right side 10b intended to be played by a user's right hand. By dividing the device 10 into two halves, it is intended that the practice device 10 will be used equally by both of the user's hands.

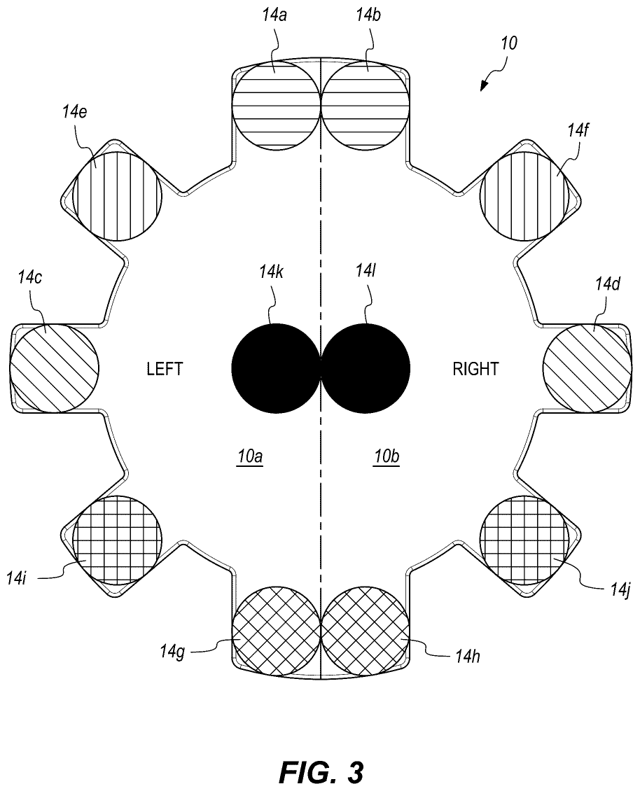

In particular, the drum coordination device 10 includes three main components: a generally circular platform 12, a plurality of circle pads 14, and connecting devices 16 configured to secure the circle pads 14 to the platform 12. In one embodiment, there are twelve circular pads 14 disposed on the platform 12. In certain embodiments, the circular pads 14 are disposed on the platform 12 as shown in FIG. 3, wherein two pads 14a, 14b are situated side by side at the top of the platform 12. Two pads 14c, 14d are situated on opposite sides of the platform 12. Two pads 14c, 14f are situated between the top pads 14a, 14b and the side pads 14c, 14d. Two pads 14g, 14h are situated side by side on the bottom of the platform 12. Two pads 14i, 14j are situated between the bottom pads 14g, 14h and the side pads 14c, 14d. And, finally in this embodiment, two pads 14k, 14l are situated side by side in the center of the platform 12. It is envisioned that the pads on the left side of the platform 10a will be struck by a drumstick in the user's left hand and the pads on the right side of the platform 10b will be struck by a drumstick in the user's right hand.

Using the drum coordination device 10, each hand will learn to practice individually thereby developing precision, skill, and strength in each hand. While a user can practice with the device 10 in various ways, it is envisioned that a preferred method of practicing would include the user beginning first with the right hand and then following suit with the left hand. By doing so, each hand will learn to play in an equal manner. By doing so, a user will build strength, precision, skill, stick control, and well-rounded coordination in both hands. It is intended that through use of the drum coordination device, a right-handed drummer will gain equal skill in their left hand, and a left-handed drummer will gain equal skill in their right hand, thereby creating ambidextrous individuals and well-rounded drummers.

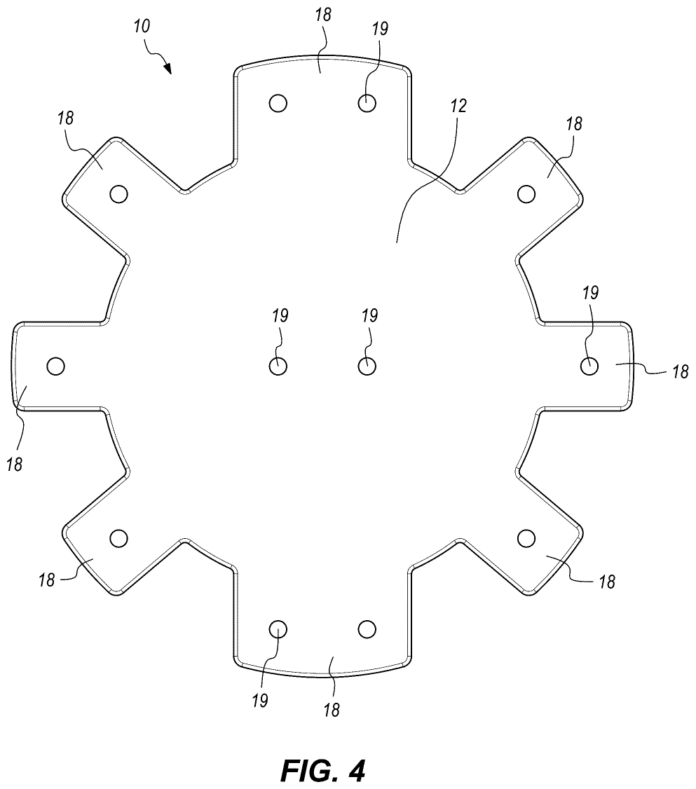

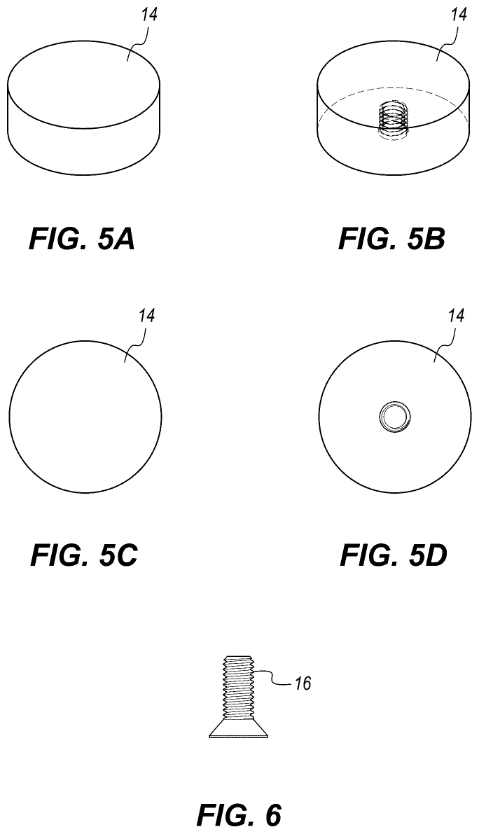

As shown in FIG. 4, the platform 12 is generally circular, and may include extensions 18 extending outward from the platform 12. In particular, in one embodiment shown herein, there are eight extensions 18 extending outward from the platform 12 in a radial fashion, with the top and bottom extensions 18 being wider than the other six extensions 18. The platform 12 may have holes 19 drilled through it to allow for the attachment of the circular pads 14. In one embodiment shown herein, each of the six smaller extension 18 have a hole 19 drilled throughout, the wider top and bottom extensions 18 have two holes 19 drilled side by side, and there are two holes 19 drilled side by side in the center of the platform 12. A connecting device 16, such as a screw, may be inserted through each hole 19 and attached to a circular pad 14 to secure the circular pad 14 to the platform 12. While it is disclosed to use a screw, it is envisioned that any securing method could be utilized, such as bolts, nails, or forming the circular pads into the platform 12, for example. The platform 12 can be made of any color but in certain embodiments it is made of a grey color. The platform 12 may be made from any of a variety of materials, for example, rubber, silicone, plastic, wood, metal, or combinations thereof. It is envisioned that the platform 12 could be formed from recycled materials to be environmentally friendly.

The circular pads 14 may be formed of various colors. In one embodiment shown herein, there are two blue pads, two red pads, two green pads, two yellow pads, two orange pads, and two black pads. In certain embodiments, the circle pad 14 is generally cylindrical in shape and has a threaded insert on the bottom side to allow for the connecting device 16 to be inserted into the circular pad 14 to secure the pad to the platform 12. The circular pads 14 may be removable to replace worn out pads, and/or to add variation to the drum coordination device 10.

The drum coordination device 10 is highly portable and usable in various setups, for example, it could be played on the floor with a user also sitting on the floor, it could be played in the user's lap when sitting down, it could be placed on a table or other elevated surface for the user to play the pad 10. However, there could additionally be utilized a holder that attaches the drum coordination device 10 to a standard snare drum stand in a drum kit, in such a way that a user could swap out a snare drum from the snare drum stand, and replace it with the drum coordination device 10 for the practice and benefits described herein when using the drum coordination device 10. Various ways of attaching the drum coordination device 10 to the snare stand could be used, but one particular example would be a generally circular holder that features a lip or rim sized to contain and hold on to the drum coordination device, that would then be attached to the snare stand. One within the art would readily be able to devise such a holder, but it is envisioned that the holder could be a 14-inch circular rim in order to hold the device 10 in place on the snare stand while the user practices with the device 10.

In another embodiment, there is envisioned a foot coordination device 20 with a similar layout to that described above. In particular, the foot coordination device 20 features the same twelve-circular pad 24 layout, but in a larger mat-like format, intended to be placed on the ground or other level surface. The foot coordination device 20 will follow similar exercises as described above for the drum coordination device 10, but is intended to be used by the user's feet to strike the circular pads 24. By using the foot coordination device 20, a user will increase the strength and dexterity in each of their feet and legs. This will allow the user to achieve an exercise-like workout when using the foot coordination device 20. It is envisioned that this device 20 will increase a user's body coordination, improve their walking ability, train their legs to improve in other sports (cross-training), benefit a user when dancing, and teach each foot of the user to perform better than without the use of the foot coordination device 20.

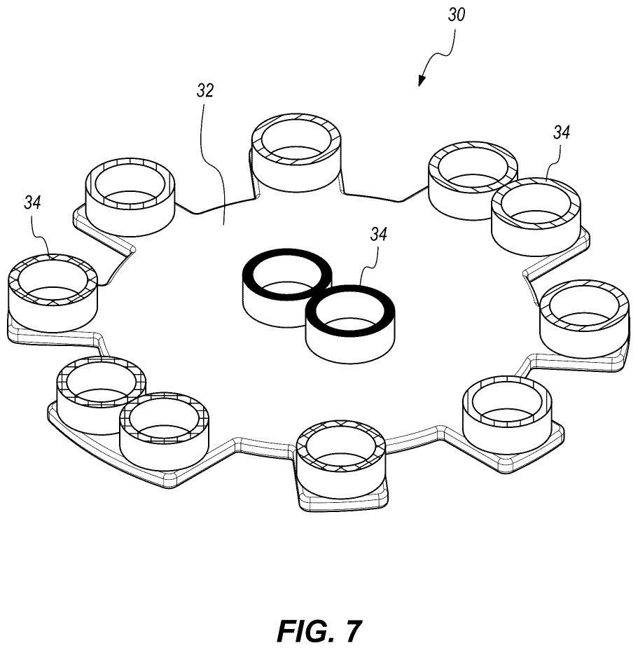

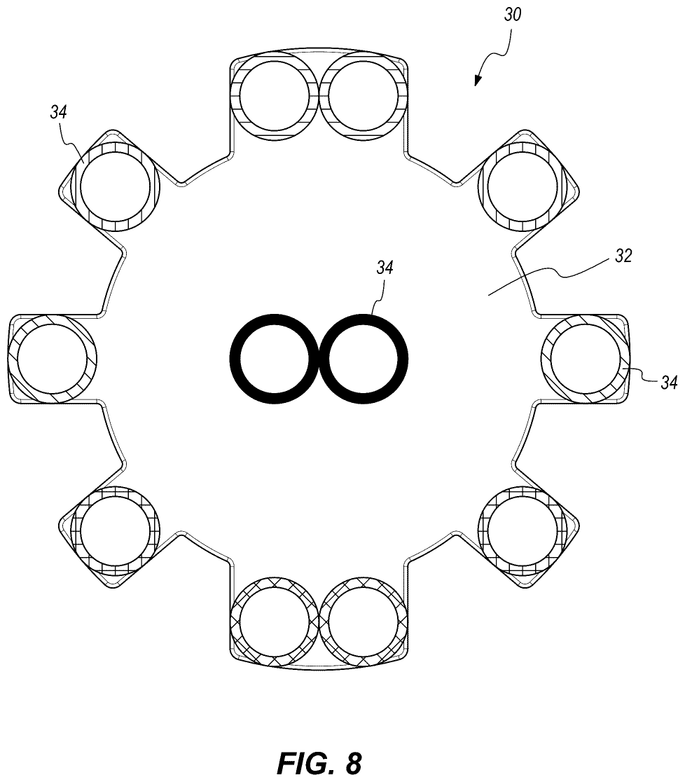

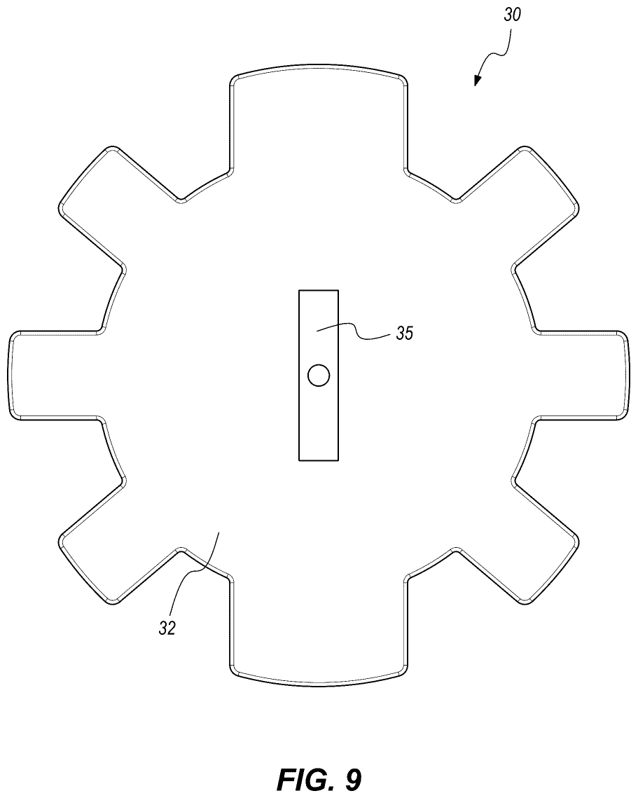

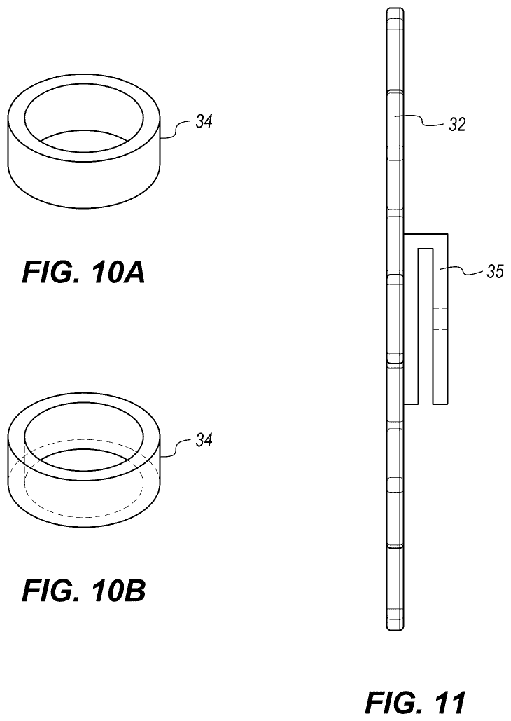

In another embodiment, shown in FIGS. 7-11 there is envisioned a toss coordination device 30 with a similar layout to that described above. In this embodiment, attached to the platform 32 are twelve hollow cylinders 34. In this embodiment, it is envisioned that a user will toss projectiles, for example bean bag balls, into the hollow cylinders 34. As with the drum coordination device 10, a user will toss the balls into the left cylinders 34 with their left hand, and will toss the balls in the right cylinders 34 with their right hand. In this embodiment, you could have balls that match the colors of the cylinders 34. For example, a user would start with their right hand and toss a blue ball into the blue cylinder, a red ball into the red cylinder, etc. The user would then likewise use their left hand to throw a blue ball into the blue cylinder, a red ball into the red cylinder, etc. This embodiment may further include a distance mat (not shown). The distance mat may have various distance marks disposed on the mat. The mat would be placed below the toss coordination device 30 and extend outward so that the user would know their distance from the device 30. The mat could be marked with different distances for different users' abilities, for example with marks from one foot away up to ten feet away from the device 30 for more advanced users. It is envisioned that the device 30 would be mounted in a substantially vertical fashion, for example on a wall or on a freestanding stand. The toss coordination device 30 may include three components: a platform 32, a plurality of hollow cylinders 34, and a mounting adapter 35.

Similar to that described above, the platform 32 may be made of various colors and out of various materials. The hollow cylinders 34 will be disposed in substantially the same pattern as described above in relation to the drum coordination device 10. The hollow cylinders 34 may be attached in various ways, including being glued on to the platform 32 or otherwise permanently or removably attached, or may even be formed into the platform itself. It is envisioned that this embodiment would include a mounting adapter 35 on the back that would allow the toss coordination device 30 to be attached to a freestanding stand or mounted to a wall.

It is envisioned that using the toss coordination device 30 will benefit a user in multiple ways, such as increasing their focus, helping them relax, teaching them patience, teaching them to finish tasks, teaching them to concentrate, exercising their hands and arms, and training each hand to perform better through consistent use.

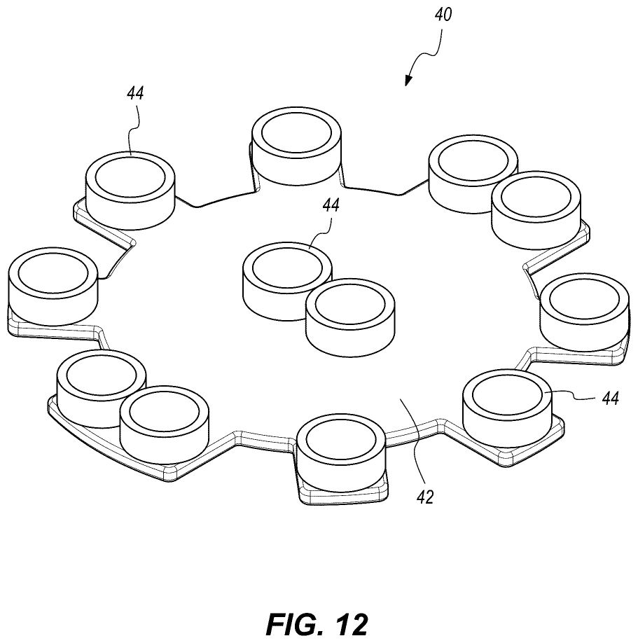

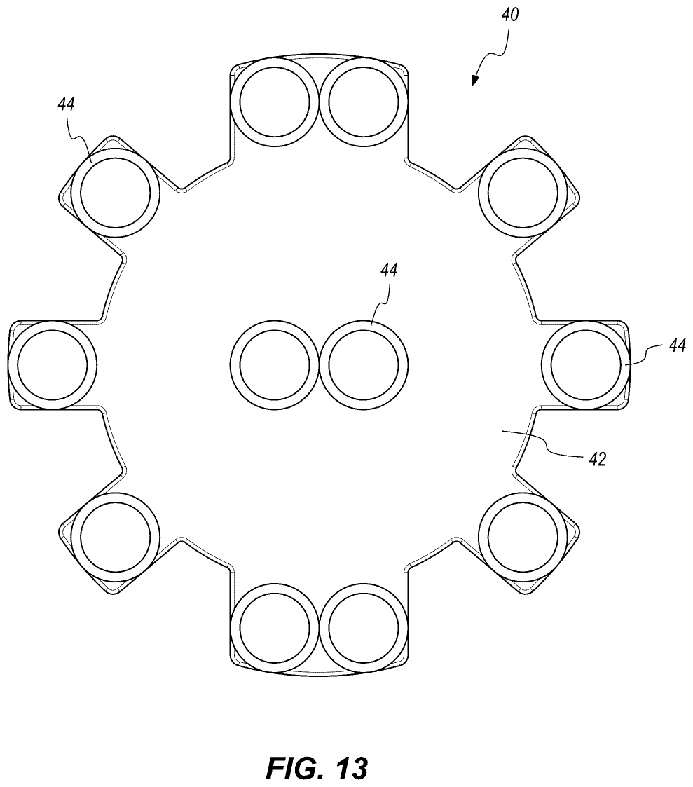

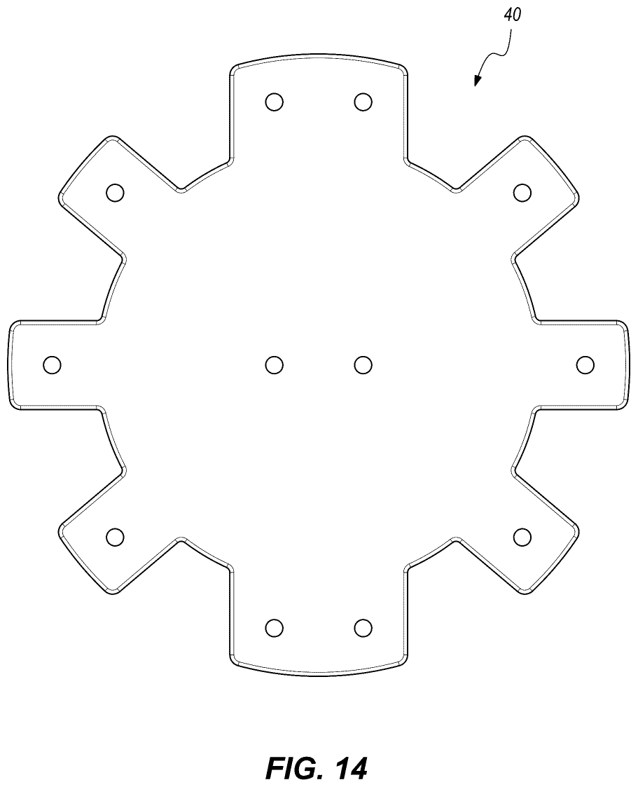

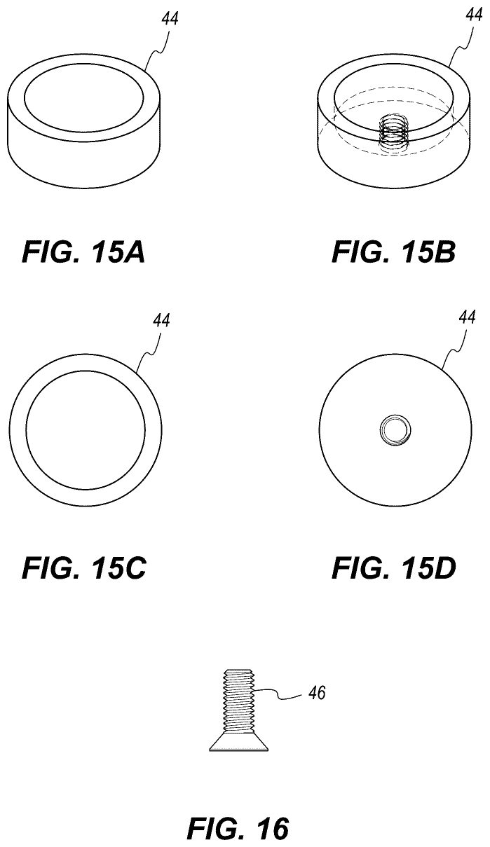

In another embodiment, shown in FIGS. 12-16, there is envisioned a dart (or magnetic) coordination device 40 with a similar layout of dart pads 44 to that described above. In this embodiment, a user will throw darts, either magnetic or traditional, at the dart coordination device 40 utilizing the same right hand and left hand training exercises as described above. As with the toss coordination device 30, there may be darts that match the colors of the pads 44 on the dart coordination device 40, such that a user will throw a red dart at the red pad, a blue dart at the blue pad, etc. In this embodiment, the circular pads 44 may be metal pieces, wherein the corresponding darts have a magnetic tip, such that when a user throws the magnetic dart it sticks to the metal pad 44. In this embodiment, the platform 42 itself would be formed from metal as well, so that darts missing the circular pads 44 would still stick to the platform 42 itself. Alternatively, the circular pads 44 may be made from a more traditional dartboard material and the user would throw traditional darts at the circular pads 44. Another embodiment would have the circular pads 44 having a plurality of preformed holes formed within, and the user would throw plastic-tipped darts, such that the plastic tips are capable of being secured into the preformed holes when thrown at the circular pads 44. This embodiment may also have a mounting adapter to allow the dart coordination device 40 to be attached to a wall or to a freestanding stand. The circular pads 44 in this embodiment may be secured to the platform 42 with a connecting device 46 or may be formed directly into the platform 42. Similarly to the toss coordination device 30, it is envisioned that this device 40 will serve many of the same benefits including the increase in hand-eye coordination for both of a user's hands.

Any of the above-described embodiments may further include an electronic variation, wherein the pads can be programmed for different sounds, for example different drum kit component sounds. In this electronic variation, there would be electronic components to allow for the programming of each pad to make the same or different sounds when struck. The pads would include input sensors to register when struck by a user and would include output sound components so that the user is able to hear the programmed noise when the pad is struck. Various ways of outputting the sounds could be utilized, for example the pad could further include an internal speaker capable of reproducing the programmed sound for the user to hear. Alternatively, or additionally, the pad could include an output to an external speaker, for example by attaching a cable to the pad to an external speaker, or a headphone jack for plugging in headphones, or Bluetooth or other wireless technologies for outputting the sound wirelessly to an external speaker.

The above description is given by way of example, and not limitation. Given the above disclosure, one skilled in the art could devise variations that are within the scope and spirit of the invention disclosed herein, including various shapes for the pads, including but not limited to, squares, triangles, rectangles, hexagons, and the like. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A coordination improvement device comprising:
a) a platform; and
b) a plurality of pads disposed on, and arranged around, the platform.

2. The coordination improvement device of claim 1, wherein the platform is generally circular in shape.

3. The coordination improvement device of claim 1, wherein the platform has a plurality of extensions extending outward from the platform.

4. The coordination improvement device of claim 3, wherein there are eight extensions.

5. The coordination improvement device of claim 4, wherein two of the eight extensions are wider than the remaining six extensions.

6. The coordination improvement device of claim 5, wherein two pads are disposed on each of the two wider extensions and one pad is disposed on each of the six remaining extensions.

7. The coordination improvement device of claim 6, further comprising two pads disposed in the center of the platform.

8. The coordination improvement device of claim 5, wherein the two wider extensions extend outward diametrically opposite of each other from the platform.

9. The coordination improvement device of claim 1, wherein the pads are circular.

10. The coordination improvement device of claim 1, wherein the pads are visually distinguishable in pairs.

11. The coordination improvement device of claim 10, wherein the visually distinguishable pairs are matching colors.

12. The coordination improvement device of claim 10, wherein the visually distinguishable pairs are matching patterns.

13. The coordination improvement device of claim 1, wherein there are twelve pads.

14. The coordination improvement device of claim 1, wherein the device is configured as a drum coordination device, with the plurality of pads being strikable by a drum stick.

15. The coordination improvement device of claim 1, wherein the device is configured as a foot coordination device, with the platform capable of being placed on a floor and sized such that the plurality of pads are strikable by a user's feet.

16. The coordination improvement device of claim 1, wherein the device is configured as a toss coordination device, with the plurality of pads being hollow cylinders capable of receiving a ball and the device capable of being mounted in a predominantly vertical position.

17. The coordination improvement device of claim 1, wherein the device is configured as a dart coordination device, with the plurality of pads being configured to detachably receive a dart and the device capable of being mounted in a predominantly vertical position.

18. The coordination improvement device of claim 1, wherein the device further comprises a speaker capable of playing an output when a pad is struck.

19. The coordination improvement device of claim 18, wherein the plurality of pads are programmable to make a certain sound when struck.

20. The coordination improvement device of claim 19, wherein each pad is programmable to make a different sound from other pads.
